(19) United States
(12) Patent Application Publication
(10) Pub. No.: US 2009/0183069 A1
(43) Pub. Date: Jul. 16, 2009

(54) Font/Script Association

(75) Inventors: Finbarr S. Duggan, Dublin (IE); Anna M. Tholse, Dublin (IE); Mark R. Breivik, Dublin (IE); Michael J. Doyle, Dublin (IE); Rory A. Morrison, Dublin (IE); David S. Glenn, Carnation, WA (US); Peter G. Constable, Redmond, WA (US); Nicholas A. Beal, Kirkland, WA (US); Mushegh Malkhasyan, Kirkland, WA (US); Sebastien Molines, Dublin (IE)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/014,731

(22) Filed: Jan. 15, 2008

(51) Int. Cl. G06F 17/21

(52) U.S. Cl. 715/269

(57) ABSTRACT

Font/script association techniques are described. In an implementation, a client includes one or more modules to determine which of a plurality of scripts are to be used to display characters and one or more fonts are located that correspond to the determined script. Representations are output of the located one or more fonts in a user interface that are selectable to cause the characters to be displayed using a selected one of the fonts.

### BACKGROUND

The richness that is made available to users to display characters is ever increasing. For example, fonts are continually developed to provide different designs for a set of characters, such as different size, weight, spacing, typefaces, and so on. Thus, the users may select from these different fonts to display characters in a desired manner.

Because fonts are being continually developed, however, the choices that are made available to the user can become daunting. For example, a user of a word processing program may be confronted with hundreds of different fonts. Therefore, it may be difficult for the user to select a particular font of interest or even comprehend the choices that are available to the user. Consequently, a user may forgo the rich choices that are made available from the varied fonts and instead interact with a limited subset of the fonts with which the user is familiar.

### SUMMARY

Font/script association techniques are described. In an implementation, a client includes one or more modules to determine which of a plurality of scripts are to be used to display characters and one or more fonts are located that correspond to the determined script. Representations are output of the located one or more fonts in a user interface that are selectable to cause the characters to be displayed using a selected one of the fonts.

In another implementation, one or more computer-readable media include one or more modules that are executable to provide an operating system having a plurality of fonts, each being usable to display characters and being associated with a script such that when a particular one of the scripts is selected a corresponding one of the fonts is made available for user selection in a user interface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ font/script association techniques.

FIG. 2 is a flow diagram depicting a procedure in an exemplary implementation in which fonts are associated with particular scripts through the use of metadata to manage which fonts are to be made active or inactive in a user interface.

FIG. 3 is a flow diagram depicting a procedure in an exemplary implementation in which a determination of which of a plurality of scripts are to be employed on a computer is used to manage which of the fonts are to be active or inactive for user selection on the computer.

FIG. 4 is an illustration of a user interface that is usable to set user preferences for a script and modify suggestions of scripts and fonts that are to be made active for the computer of FIG. 1.

### DETAILED DESCRIPTION

Overview

Fonts are being continually developed to provide different designs for a set of characters (such as different size, weight, spacing, typefaces, and so on) and therefore increase the “richness” that is available to output the characters. However, the choices that are made available to the user can become daunting. For example, a user may be confronted with hundreds of different fonts that are available for selection. Consequently, a user may forgo the rich choices that are made available from the varied fonts and instead interact with a limited subset of the fonts with which the user is familiar. Further, globalized software may continually ad fonts in successive versions as more and more languages and scripts are supported. Therefore, additional fonts may be supported for additional languages.

Font/script association techniques are described. In an implementation, fonts are associated with particular scripts (e.g., through the use of metadata), which are a set of characters that are used for a particular language. For example, a Latin (i.e., Roman) script is typically employed to write for the English, French and Spanish languages. Therefore, a script which is likely to be employed by a user may be used as a basis for selecting which fonts are made available for user selection. In an implementation, those fonts that are not made available for user selection may still be used to display characters such that the “richness” offered by the hundreds of different fonts is still preserved while enabling a user to select from fonts that are likely to be relevant to the user.

A variety of different techniques may be used to determine which script is likely to be used. For example, a type of keyboard layout that is used by a user in conjunction with a computer may serve as a basis for the selection. A keyboard layout that has Latin characters, for instance, may cause the computer to automatically and without user intervention set a script for the computer as “Latin”, such as through identification of a driver used to support a keyboard having the layout. In another example, a geographic location may be used to determine a particular script, whether set automatically by a manufacturer/shipper of the computer/software, input via Internet address, set manually by a user, and so on. A variety of other examples are also contemplated, such as through manual entry of user preferences by a user via a user interface, user interface language, setting set by a manufacturer or system administrator, and so on. Further discussion of these and other examples may be found in relation to the following sections.

In the following discussion, an exemplary environment is first described that is operable to perform font/script association techniques. Exemplary procedures are then described which may be employed in the exemplary environment, as well as in other environments.

Exemplary Environment

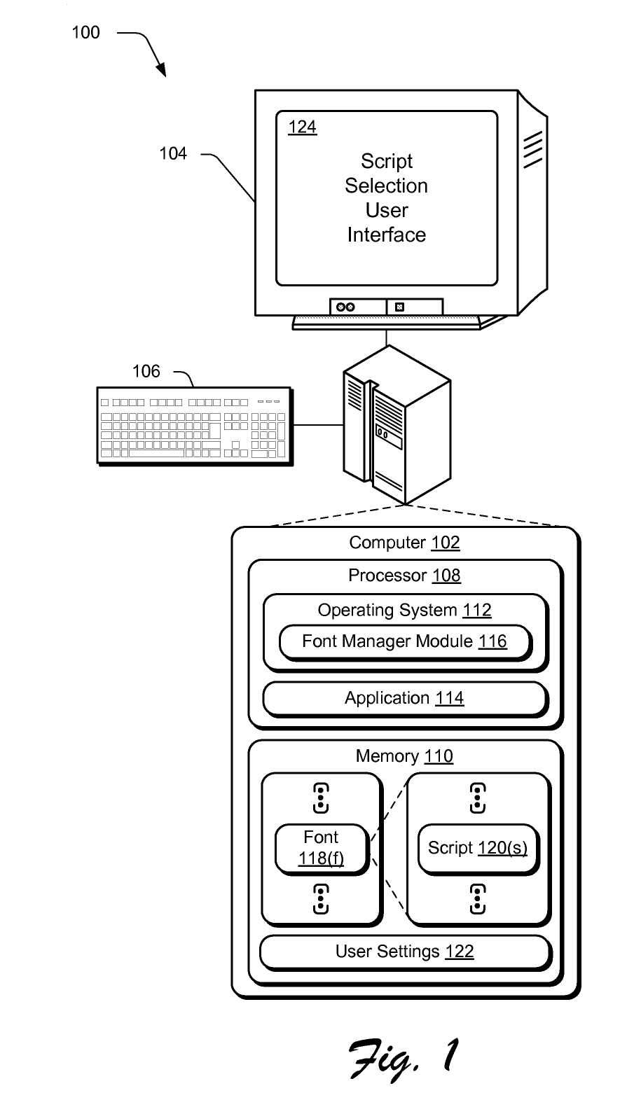

FIG. 1 is an illustration of an environment 100 in an exemplary implementation that is operable to employ font/script association techniques. The illustrated environment 100 includes a computer 102 having a display device 104 and an input device illustrated as a keyboard 106. The computer 102 may be configured in a variety of ways, such as a traditional “tower” computer as illustrated in FIG. 1, a desktop computer, a mobile station, an entertainment appliance, a set-top box communicatively coupled to a display device, a wireless phone, a game console, a portable music player, and so forth.

The computer 102 is illustrated as including a processor 108 and memory 110. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 110 is shown, a wide variety of types and combinations of memory may be employed, such as random access memory (RAM), hard disk memory, removable medium memory, and other types of computer-readable media.

The computer 102 is also illustrated as executing an operating system 112 on the processor 108, which is storable in memory 110. The operating system 112 is representative of functionality to “abstract” underlying resources of the computer, such hardware and software resources (e.g., font resources). For example, the operating system 112 may be responsible for manipulating files, scheduling tasks, managing storage (e.g., where and how data is stored in memory 110), input/output distribution, interrupt processing, and so on, which may be accessed directly by a user or indirectly through use of an application 114.

The application 114 is also illustrated as being executed on the processor 108 and is storable in memory 110. The application 114 may assume a wide variety of configurations that expose fonts for user selection. For example, the application 114 may be configured as a productivity application such as a word processing application, spreadsheet application, presentation application, illustration application, and so on. The application 114 may also be configured in a variety of other ways, such as an email application, browser application, and so on.

The operating system 112 is illustrated as including a font manager module 116 that is representative of functionality to perform font-script association techniques. Although illustrated as part of the operating system 112, the font manager module 116 may assume a wide variety of configurations, such as a stand-alone application, incorporated within application 114, accessible via a network, and so on.

The font manager module 116 may utilize a variety of techniques to manage the fonts. In a first example, the font manager module 116 separates a notion of fonts available on the computer (i.e., the installed fonts) from a notion of fonts that are to be made selectable by a user, e.g., the “active” fonts. In this example, each of the fonts available on the computer may be used, such as in a display of an email message as intended by a sender of the message. However, a subset of the installed fonts that have an increased likelihood of being relevant to the user are made selectable to enter characters and therefore “active” to the user.

Continuing with the previous example, the user may be presented with a menu in a user interface having fonts that are currently selectable by the user (i.e., “active”), but does not include each font that may be used to display text in the email message (e.g., the fonts installed on the computer 102), such as part of a portion of the email message in a “reply” from an original sender. Therefore, even though each of the installed fonts may be utilized in this example, the user is presented with a subset of the fonts for entry by the user. A variety of techniques may be employed to determine the subset.

In an implementation, the font manager module 116 manages fonts 118(f) (where “f” may be an integer between one and “F”) based on associations with one or more scripts 120(s) (where “s” may be an integer between one and “S”). The scripts 120(s) are representative of sets of characters used to represent a particular set of languages, such as a Latin (i.e., Roman) script to write English, French, Spanish and so on, a Cyrillic script to write Russian and Serbian, and so on. Thus, the script may define the actual characters used for particular languages, and in some instances a single script may correspond to a single language.

Accordingly, the font manager module 116 may determine that a particular one of the scripts 120(s) is to be used by a user of the computer 102 and make fonts 118(f) that correspond to that script 120(s) “active”, e.g., selectable for output in a user interface by a user. In an implementation, “inactive” fonts 118(f) (e.g., fonts 118(f) that do not correspond to the particular one of the scripts 120(s)) may still be used to display characters, but are not directly selectable by a user of the computer 102. For instance, representations of the “active” fonts 118(f) may be output in a first menu with representations of the “inactive” fonts 118(f) being output in a sub-menu of the first menu, representations of the fonts 118(f) may be output different portion of the menu, and so on.

The font manager module 116 may employ a variety of techniques to determine which of the scripts 120(s) is to be used. The font manager module 116, for instance, may determine that an input device configured for input of a particular script is communicatively coupled to the computer 102, such as whether the keyboard 106 as illustrated in FIG. 1 is configured for Latin input. Therefore, because the keyboard 106 is configured for output using a particular type of script 120(s) (e.g., Latin in this instance), the font manager module 116 may make fonts 118(f) that correspond to that script 120(s) “active”, provide those fonts in an initial user interface with each other “inactive” font 118(f) available via another user interface (e.g., another menu), and so on.

In another instance, the font manager module 116 may determine which script 120(s) is active based on a geographic location of the computer 102, which may be entered by a user (e.g., through entry in an initial set-up screen of the computer 102), determined automatically by the computer 102, set by a manufacturer/distributor prior to shipping of the computer 102 and/or font manager module 116 (e.g., via a computer-readable medium), and so on. The geographic location may then be used by the font manager module 116 to “look up” which of the scripts 120(s) correspond to the geographic location, and consequently which of the fonts 118(f) are to be made active.

In a further instance, user settings 122 may be stored in memory 110 of the computer 102 to specify a particular one or more of the scripts 120(s). The font manager module 116, for example, may output a script selection user interface 124 that accepts as an input which script 120(s) the user wishes to use, such as directly (e.g., Latin), indirectly through selection of a language (e.g., English for a Latin script), and so on. A variety of other instances are also contemplated, further discussion of which may be found in relation to the following exemplary procedures.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, an example of which is the memory 110 of FIG. 1. The features of the font/script association techniques described below are platform-independent, meaning that the techniques may be implemented on a variety of commercial computing platforms having a variety of processors.

Exemplary Procedures

The following discussion describes font/script association techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 although it should be readily apparent that such reference is made as an example and therefore is not limited to the environment 100 of FIG. 1.

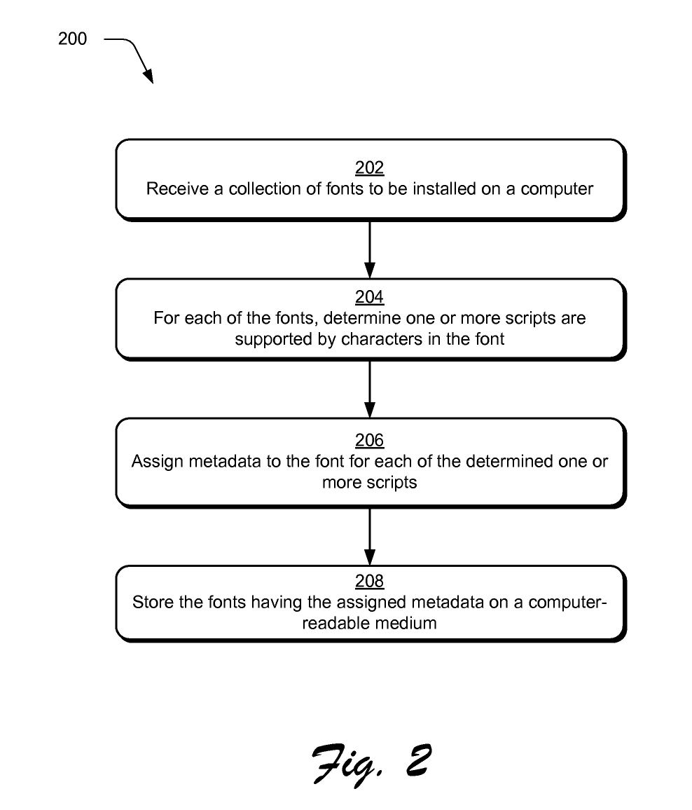

FIG. 2 depicts a procedure 200 in an exemplary implementation in which fonts are associated with particular scripts through the use of tags to manage which fonts are to be made active or inactive in a user interface. A collection of fonts are received to be installed on a computer (block 202). The collection, for instance, may be configured to be part of an operating system, part of a productivity application (e.g., a word processing program, presentation application, publishing application), and so on.

For each of the fonts, a determination is made as to which scripts are supported by characters in the font (block 204). For example, the determination may be made directly, e.g., this font corresponds to this script. The determination may also be made indirectly, e.g., the fonts may be configured for use in the English language and therefore is suitable for use as a Latin script for other languages as well such as Spanish and French.

Metadata is assigned to the font for each of the determined one or more scripts (block 206). Tags, for instance, may identify each of the scripts that use characters that are made available via the font. For example, the tags may identify the script directly instead of just languages that are supported by the script. Further, in another example this identification may indicate that particular scripts for which the font is designed, rather than scripts and/or languages supported. Thus, in this example a user is provided with options that correspond to actual intended use of the fonts as indicated by a designer and/or distributor of the fonts. A variety of other examples of metadata are also contemplated. For example, the metadata may incorporate additional attributes, such as particular languages, regions that may also be used as a basis for comparison, e.g., with user preferences.

The fonts having the assigned metadata are stored on a computer-readable medium (block 208). For example, the computer-readable medium may include the operating system 112 and/or application 114. The operating system 112 and/or the application 114 may include the fonts to provide desired functionality, such as to make available a rich range of choices for user selection. The tags assigned to the fonts 118(f) may then be used by a font manager module 116 to manage user interaction with the fonts, an example of which is discussed in relation to the following procedure.

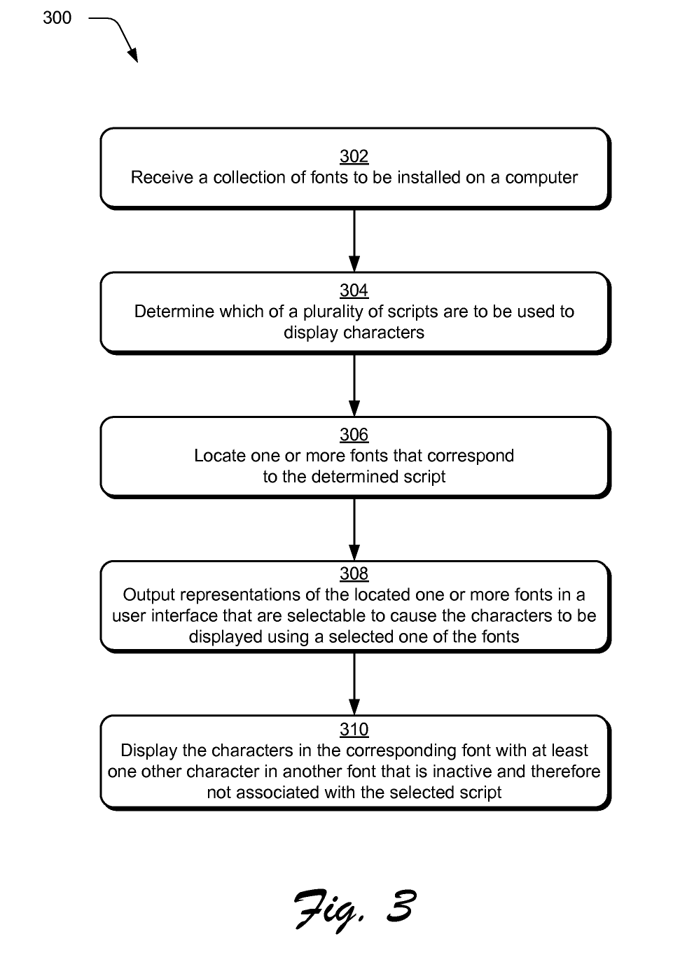

FIG. 3 depicts a procedure 300 in an exemplary implementation in which a determination of which of a plurality of scripts are to be employed on a computer is used to manage which of the fonts are to be active or inactive for user selection on the computer. A collection of fonts is received to be installed on a computer (block 302). For example, the collection may be part of an operating system 112 that is to be installed on the computer 102 by a manufacturer of the computer 102, by a purchaser of the computer 102, and so on.

A determination is made as to which of a plurality of scripts are to be used to display characters (block 304). This determination may be made in a variety of ways. Continuing with the previous example, the manufacturer may install the operating system 112, during or after which, and indicate that the operating system 112 is to employ a particular script. This indication may be made directly (e.g., input of the actual script name) and/or indirectly, such as through input of a geographic location where the computer 102 is to be sold and/or used or through configuring the computer for use of a particular language or languages.

In another example, the determination may be based on an input device that is attached to the computer 102. For instance, the keyboard 102 as illustrated in FIG. 1 may be configured for use with a Latin script. Therefore, installation of the keyboard 106 with the computer 102 may indicate that a Latin script is to be used on the computer 102. A variety of other input devices may also be used to indicate particular scripts.

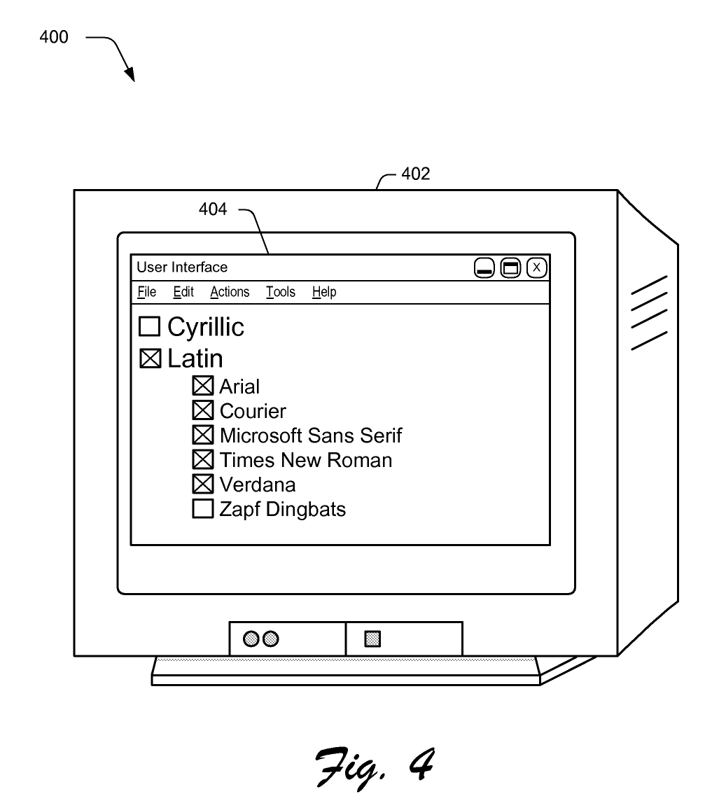

In a further example, user settings 122 may be used to indicate a particular script. Referring to FIG. 4, for instance, a display device 402 for the computer 102 of FIG. 1 is shown as outputting a user interface 404 that provides for manual selection of scripts. The user interface 404 is shown as including check boxes that may be used to specify particular scripts, an example of which is illustrated as “Latin” in FIG. 4. Thus, a user may manually set the script and/or reset the script, such as to override automatic selections, further description of which may be found later in the discussion. A variety of other examples of indicating are also contemplated, such as the geographical location example previously described in relation to FIG. 1.

One or more fonts are then located that correspond to the determined script (block 306). The fonts 118(f), for instance, may be located in memory 110 using metadata (e.g., tags) that identify respective scripts 120(s), based off a list (e.g., an XML document) that identifies font 118(f)/script 120(s) associations, and so on.

Representations of the located one or more fonts are output in a user interface that are selectable to cause the characters to be displayed using a selected one of the fonts (block 308). For example, application 114 when configured as a word processing application may output a drop-down menu in a user interface having a list of the located fonts 118(f), i.e., fonts 118(f) that are “active” for user selection, to display one or more characters. Thus, rather that output a representation of each of the fonts 118(f) that are installed on the computer 102, the drop-down menu in this example may output representations of those fonts 118(f) that are likely to be used by the user of the computer 102. It should be noted that even though the representations of “inactive” fonts 118(f) are not output in this example, those fonts may still be used to display characters. Thus, the characters may be displayed in the corresponding font to a selected script with at least one other character in another font that is inactive and therefore not associated with the selected script (block 310). A variety of other examples are also contemplated.

For example, selections of which of the fonts 118(f) are active or inactive may initially be performed by the font manager module 116 as suggestions to a user. A user interface may then be output such that the user of the computer 102 may manually override the suggestions. Returning to FIG. 4, suggestions of fonts 118(f) that correspond to a script 120(s) are illustrated as “Arial”, “Courier”, “Microsoft Sans Serif”, “Times New Roman” and “Verdana” for the “Latin” script. An option is provided to make other fonts and/or scripts “active” that were not part of the suggestion, which in this example are the “Zapf Dingbats” font and the “Cyrillic” script. Thus, a user of the computer 102 may manually provide user settings 112 which may be used to set and/or modify scripts 120(s) and/or fonts 118(f) chosen for the computer 102.

In the previous examples, association of a font with a particular script was described. In some instances, however, the font may be relevant regardless of the script and is thus “generic” to the scripts. In such an instance, representations of the generic font may be made user selectable regardless of the script that is determined to be relevant to the user. For example, if a particular item of software is configured such that each user has access to one or more particular fonts for specific operation purposes or if the software provides fonts that supports characters that would be of general interest to each user, such as certain symbols, then such fonts may be treated as generic in relation to scripts.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A client comprising one or more modules to:
determine which of a plurality of scripts are to be used to display characters;
locate one or more fonts that correspond to the determined said script; and
output representations of the located one or more fonts in a user interface that are selectable to cause the characters to be displayed using a selected said font.

2. A client as described in claim 1, wherein each said script corresponds to a set of said characters that are usable for a particular set of languages.

3. A client as described in claim 2, wherein at least one said script is Latin and another said script is Cyrillic.

4. A client as described in claim 1, wherein the determination is based at least in part on a configuration of an input device that is usable to enter the text.

5. A client as described in claim 4, wherein the input device is a keyboard.

6. A client as described in claim 1, wherein the determination is based at least in part on one or more user preferences.

7. A client as described in claim 1, wherein the determination is based at least in part on an indication of a geographic location.

8. A client as described in claim 1, wherein the one or more fonts that correspond to the determined said script are located based on metadata that is associated with the one or more fonts that specify one or more respective said scripts.

9. A client as described in claim 1, wherein the output is performed such that at least one said font that does not correspond to the determined said script does not have a representation included in the user interface.

10. A client as described in claim 9, wherein the at least one said font that does not correspond to the determined said script is still usable to display characters even when the representation is not included in the user interface.

11. A client as described in claim 1, wherein the output is performed such that at least one said font that is generic to the determined said script has a representation included in the user interface.

12. A client as described in claim 1, wherein the one or more modules that perform the determination, the location and the output are part of an operating system.

13. A client as described in claim 12, wherein the one or more modules, when part of the operating system, are accessible by a plurality of applications to output the representations of the located one or more fonts in the user interface within each said application that are selectable to cause the characters to be displayed using the selected said font

14. One or more computer-readable media comprising one or more modules that are executable to provide an operating system having a plurality of fonts, each being usable to display characters and being associated with a script such that when a particular said script is selected corresponding said fonts are made available for user selection in a user interface.

15. One or more computer-readable media as described in claim 14, wherein the particular said script is selected based on a configuration of an installed input device.

16. One or more computer-readable media as described in claim 14, wherein the particular said script is selected based on an input geographic location.

17. One or more computer-readable media as described in claim 14, wherein:
each said font is usable to display the characters regardless of whether the font is represented in the user interface for user selection; and
at least one said font that does not correspond to the particular said script is not made available for user selection in the user interface.

18. One or more computer-readable media as described in claim 14, wherein the operating system is configured to provide the user interface for output by a plurality of applications.

19. A method comprising:
displaying representations in a user interface of one or more fonts that are active based on association with a selected script such that each said representation is selectable to cause characters to be displayed in a corresponding said font; and
displaying the characters in the corresponding said font with at least one other character in another font that is inactive and therefore not associated with the selected script.

20. A method as described in claim 19, wherein:
the other font does not include a representation in the user interface that is selectable; and
the at least one character is displayable in the other font.
